(19) United States
(12) Patent Application Publication
(10) Pub. No.: US 2007/0175528 A1
(43) Pub. Date: Aug. 2, 2007

(54) Multiple valve

(76) Inventor: Rune Ivar Haug, Rorvik (NO)

Correspondence Address: Jeffrey S Whittle;Bracewell & Giuliani, PO Box 61389, Houston, TX, 77208-1389, US

(21) Appl. No.: 10/551,849

(22) PCT Filed: Apr. 1, 2004
(86) PCT No.: PCT/NO04/00096

§ 371 Date: Dec. 1, 2006

(30) Foreign Application Priority Data
Apr. 2, 2003 (NO) 20031504

(51) Int. Cl. F16K 11/065

(52) U.S. Cl. 137/625.18

(57) ABSTRACT

A multiple valve for controlling the distribution of a plurality of pumpable materials. The valve has a slide (15) with a plurality of outlet openings (25) in a row. Each outlet opening (25) has a protruding tubular connection element (27) downstream on the slide (15). The slide (15) is arranged on a carrier, which is a stationary disk (11) having at least two parallel rows (19, 21) of openings (20) corresponding to the row of outlet openings (25) of the slide (15). A tubular inlet element (26) is connected to each opening (20) on the reverse, upstream side of valve carrier (11). Each row of openings is arranged perpendicularly to the direction of movement on the slide (15).

The present invention relates to a multiple valve as described in the introduction to claim 1. Such valves can be utilized for several purposes in the industry as well as for handling of pumpable goods for various distribution purposes.

### BACKGROUND OF THE INVENTION

Valves for controlling the distribution of a pumpable material, are known, comprising a slide with an outlet, said slide being arranged on a carrier comprising an inlet The slide is provided for movement between a position in which the outlet communicates with the inlet and a position in which the inlet is closed by the slide.

Known valves of this kind have been suitable for less demanding purposes, e.g. controlling the outlet of flowable or pumpable goods from a storage container into a smaller receptacle in a manually controlled emptying process.

For various purposes, pumpable goods should be distributed from a series of containers or storage tanks to a corresponding multitude of receiving units. One such purpose is the distribution of fish fodder from two or more storage tanks to a multitude of net cages for fish farming. For such applications, known valves have not been suitable.

### OBJECT OF THE INVENTION

The main object of the invention is to provide a multiple valve for distributing pumpable goods, particularly particulate or powdered masses, from a plurality of inlets to a plurality of outlets or receiving units. Such a multiple valve should combine the demand for space saving and simple design, with the operating requirements, including a long service life.

A further object is to provide av multiple valve which can be used as an interchange between one group of inlets and two or more groups of outlets, or vice versa.

### THE INVENTION

The invention is described in claim 1. With a valve according to the invention, the requirements outlined are met successfully. The novel valve can be designed for various numbers of inlets and outlets, including several groups of inlets, without changing its basic structure. This reduces the engineering needed for providing a large range of different valves and also reduces the number of different elements and components needed for manufacturing such a range of valves.

The main advantage of the novel valve resides in its adaptability to various purposes, both in regard of handling different materials and distribution tasks, and in regard of capacity for various numbers of interchanges.

The multiple valve according to the invention can be used for handling pumpable goods in different industries, including the food processing industry, metallurgy, cement industry and for other bulk handling purposes.

The valve according to the invention is easy to maintain, with simple parts, which are easily replaced.

Further features of the invention are stated in the claims 2-7.

As most valves according to the invention are bidirectional or can be reversed, in all places in the following text, the notations “inlet” and “outlet” may thus be interchanged.

### EXAMPLES

In the following, embodiments of the present invention will be described with reference to the enclosed drawings, where:

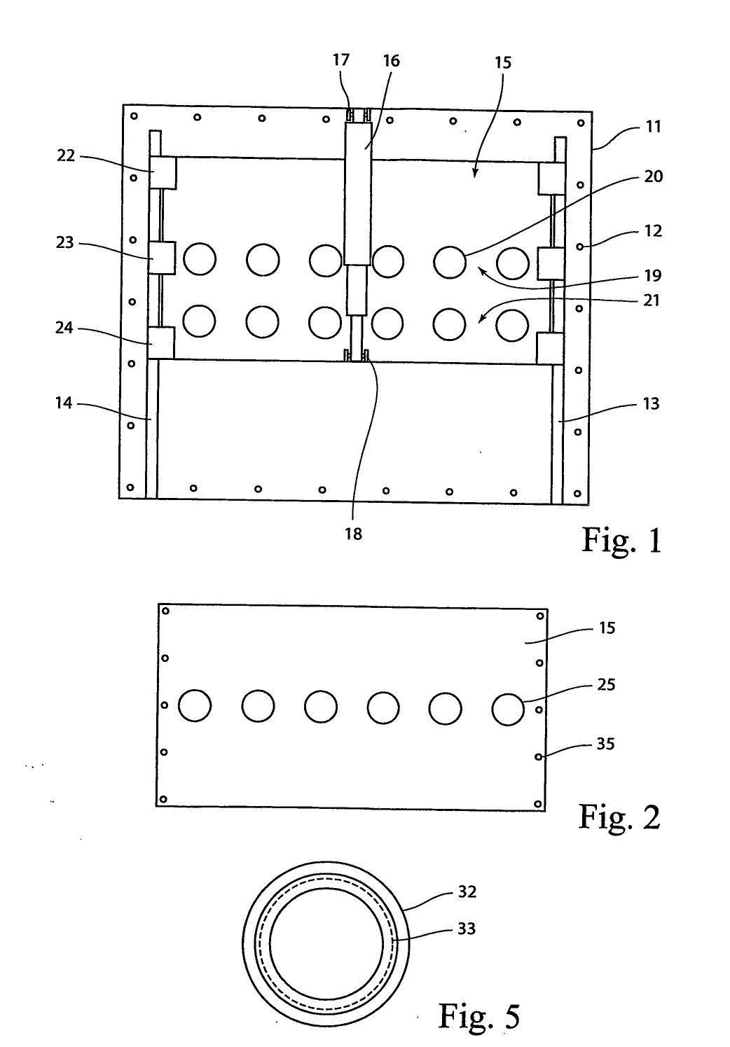

FIG. 1 shows a front view of a multiple valve according to the invention,

FIG. 2 shows a front view of a slide for the multiple valve in FIG. 1,

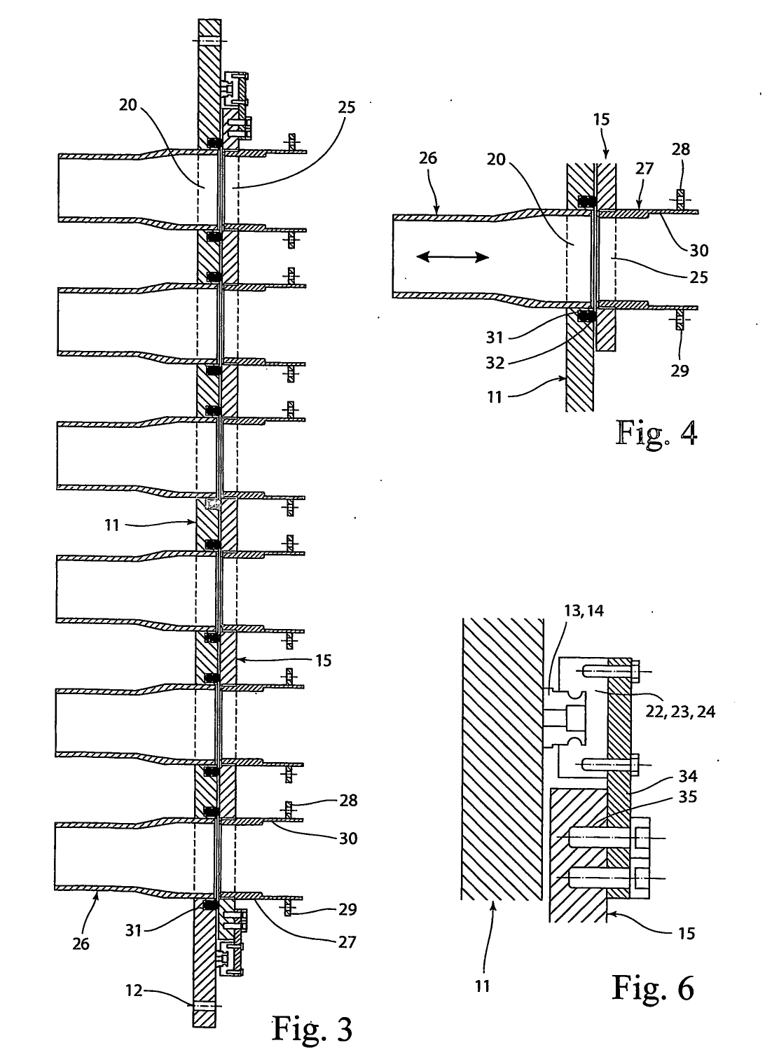

FIG. 3 shows a sectioned view of the inlets and outlets of the embodiment of FIG. 1, with the valve in one of its open positions,

FIG. 4 shows a section of FIG. 3 in a larger scale,

FIG. 5 shows a front view of a gasket for use in the shown multiple valve, and

FIG. 6 shows a sectioned end view of the connection between the carrier and the slide in larger scale than FIG. 3.

In FIG. 1 shows an embodiment of the invention, with a rectangular multiple valve carrier 11 comprising a plate with series of holes 12 along the edges, for attachment to a supporting structure, e.g. a wall or partition with an opening. At opposite side edges, two rails 13 and 14 are arranged, which will be described in more detail with reference to FIG. 6. Between the rails 13 and 14, a slide 15 is arranged for movement parallel to the rails, operated by a power cylinder 16 attached between a stationary attachment 17 at the upper edge of the valve carrier 11 and an attachment 18 on the slide 15.

The multiple valve carrier of this embodiment has an upper row or array 19 of six inlet opening 20, and a parallel lower row 21, also with six inlet openings. The inlet openings 20 may e.g. be connected to a corresponding number of tanks for pumpable goods.

The number of parallel rows and the number of openings in each row may vary with the purpose and field of use of the valve. The axial distance between the openings of the rows 19 and 21 is at least twice the diameter of the inlet openings 20.

For carrying the slide 15 on the multiple valve carrier 11, the slide 15 has three sets of rollers assemblies 22, 23, 24 at each side edge, the roller assemblies engaging slidably with the respective rails 13, 14 as shown also in FIG. 6.

In FIG. 2 a slide 15 is shown in front view, with six outlet openings 25, the arrangement of which corresponds to the arrangement of the inlet openings of the rows 19 and 21. Due to this arrangement, the outlet openings 25 of the slide 15 will mate with the respective of the inlet openings 20 of the upper or lower row of the valve carrier 11 when the slide 15 is moved in the corresponding position.

Along the side edges of the slide 15, holes 35 for attachment of the roller assemblies as shown in FIG. 6 are shown.

In FIG. 3, the arrangement and the inlet openings 20, and the outlet openings 25 is shown in more detail. Each of the inlet openings 20 of the rows 19 and 21 arranged on the multiple valve carrier 11 is provided with a pipe socket 26 extending through the multiple valve carrier 11. Similarly, pipe sockets 27 are shrink fit into each of the outlet openings 25 of the slide 15. At the free end of the outlet pipe sockets 27, a pair of radial lugs 28,29 are arranged on opposite sides for the attachment of a hose or tube for transferring pumpable material to a destination. The outlet pipe socket 27 has an inner recess 30 at the end. The pipe sockets 26 have a tapered free end.

In FIG. 4 a detail of the structure of the valve carrier—slide—cooperation is shown. At each inlet opening 20, an annular groove 31 is arranged concentric to the opening, facing the slide 15. In this groove 31 an annular gasket 32 is provided. The annular gasket 32 may be of a polymer or rubber and it is projecting slightly from the face of the multiple valve carrier 11 for bridging any gap between the valve carrier 11 and the slide 15 to provide a sealing

In FIG. 5 the annular gasket 32 is shown with an end face indicated at 33.

In FIG. 6 an enlarged section of FIG. 3 is shown to illustrate the engagement between the roller assemblies 23-25 and the rails 13, 14. The roller assemblies 23-25 comprises rollers in a holder carried by a flange 34 attached at the edge of the slide 15. The rollers are engaging slideably with the rails 13, 14.

The embodiment of the figures can be modified in regard of number of openings in each row, number of rows on each side. the number of rows of inlet openings 20 may be 2-4, while the number of rows of outlet openings 25 may be 1-2.

As the multiple valve of the invention is bidirectional, or may be have the flow of goods reversed, he notations “inlet” and “outlet” above can be reversed.

1. A multiple valve for controlling the distribution of a plurality of pumpable materials, comprising:
a stationary disk (11);
a slide (15) arranged for movement between different positions on the stationary disk (11);
a slide moving means (16) connected to the slide;
the slide (15) having a plurality of outlet openings (25) in a row;
each outlet opening (25) having a protruding tubular connection element (27) on a downstream side of the slide (15);
each of the tubular connection elements (27) having a free end for releasable connection to a conduit;
the stationary disk (11) having at least two parallel rows (19, 21) of openings (20) corresponding to the row of outlet openings (25) of the slide (15);
a tubular inlet element (27) connected to each opening (20) on a reverse, upstream side of the stationary disk (11); and
each row of openings in the stationary disk (11) being arranged perpendicularly to the direction of movement of the slide (15).

2. A valve according to claim 1, wherein the number of rows of inlet openings (20) are 2-4, while the number of rows of outlet openings (25) are 1-2.

3. A valve according to claim 1, wherein the axial distance between the rows (19, 21) of the stationary disk (11) is at least twice the diameter of the openings (20).

4. A valve according to claim 1, wherein each opening (20) of the carrier (11) is surrounded by an annular groove (31) facing the slide (15), an annular gasket member (32) being inserted into each groove (31).

5. A valve according to claim 1, wherein the slide (15) has parallel side edges perpendicular to the row of outlet openings (25), engaging two parallel guides (13, 14), each adjoining an edge for guiding the movement of the slide (15) on the carrier (11).

6. A valve according to claim 5, further comprising at least two carrier units (23-25) on each side edge of the slide (15) to movably engage the guides (13, 14).
